(19) United States
(12) Patent Application Publication
(10) Pub. No.: US 2005/0078706 A1
(43) Pub. Date: Apr. 14, 2005

(54) Distributing data from a DS3 signal over a packet switched backplane

(76) Inventor: David M. Spencer, Carrollton, TX (US)

Correspondence Address: MOTOROLA, INC., Corporate Law Department - #56-238, 3102 North 56th Street, Phoenix, AZ, 85018, US

(21) Appl. No.: 10/685,901

(22) Filed: Oct. 14, 2003

(51) Int. Cl. H04J 3/22

(52) U.S. Cl. 370/469; 370/466

(57) ABSTRACT

A multi-service platform system (100) includes a switch node (102, 104) coupled to receive a DS3 signal (114, 116), wherein the DS3 signal is translated to a packet-based signal (115) at the switch node. A packet switched backplane (110) couples the switch node and a plurality of payload nodes (106, 108), wherein data from the DS3 signal is distributed to one or more of the plurality of payload nodes via the packet switched backplane.

### BACKGROUND OF THE INVENTION

In current multi-service platform systems, interconnection of components is accomplished through the use of a backplane, which can provide high rates of data transfer between components. High rates of data transfer are generally achieved though the use of a packet switched backplane. In prior art multi-service platforms, particularly in telecom applications, a small number of digital signals that are transmitted using pulse-code modulation (PCM) or time-division multiplexing (TDM) are received and processed directly at a payload node. In this scheme, each payload node requires an independent connection to a given digital signal, as the digital signal is not packetized and can therefore not be transmitted across the packet switched backplane. This prior art method requires more cabling and is inefficient, as digital signals cannot be transferred across the packet switched backplane.

Accordingly, there is a significant need for an apparatus and method that overcomes the deficiencies of the prior art outlined above.

### BRIEF DESCRIPTION OF THE DRAWINGS

Referring to the drawing:

FIG. 1 depicts a block diagram of a multi-service platform system according to one embodiment of the invention; and

FIG.2 illustrates a flow diagram according to an embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings, which illustrate specific exemplary embodiments in which the invention may be practiced. These embodiments are described in sufficient detail to enable those skilled in the art to practice the invention, but other embodiments may be utilized and logical, mechanical, electrical and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact. However, “coupled” may mean that two or more elements are not in direct contact with each other, but yet still co-operate or interact with each other.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

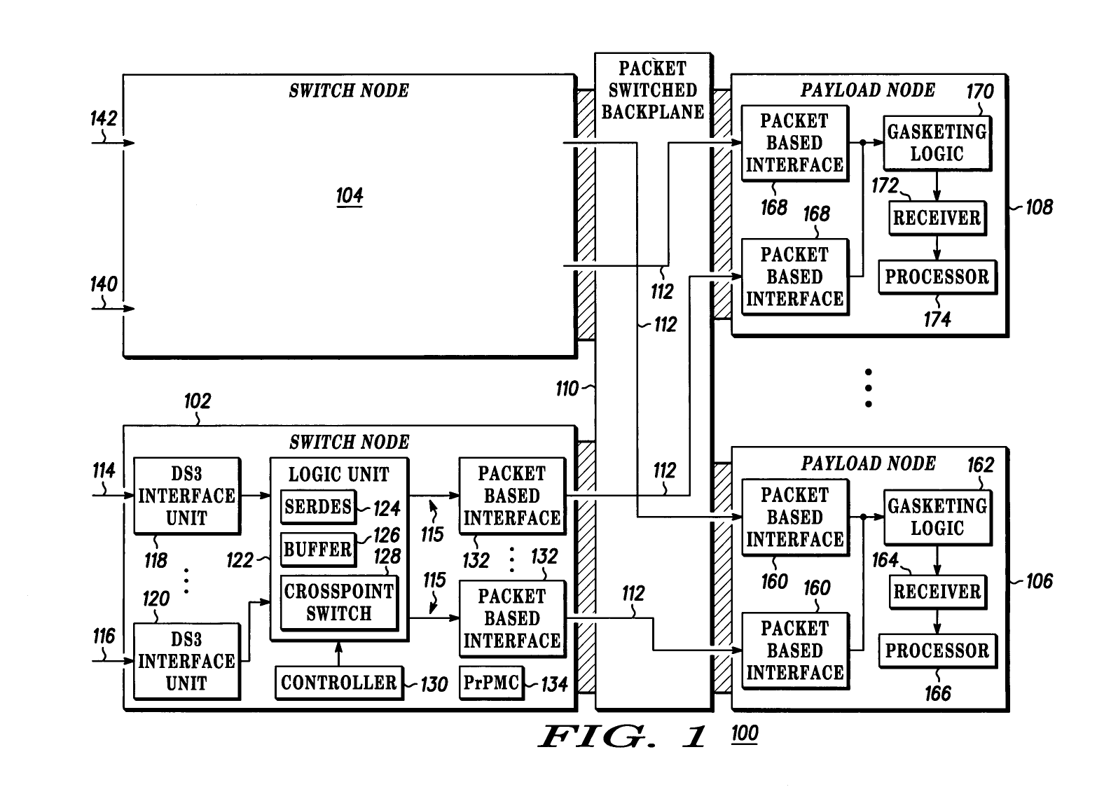

FIG. 1 depicts a block diagram of a multi-service platform system 100 according to one embodiment of the invention. Multi-service platform system 100 can include a multi-service platform system chassis, with software and any number of slots for inserting nodes, for example, switch nodes 102, 104 and payload nodes 106, 108. Packet switched backplane 110 is used for connecting nodes placed in slots. As an example of an embodiment, a multi-service platform system 100 can include chassis having model MVME5100 manufactured by Motorola Computer Group, 2900 South Diablo Way, Tempe, Ariz. 85282. The invention is not limited to this model or manufacturer and any multi-service platform system is included within the scope of the invention.

As shown in FIG. 1, multi-service platform system 100 can comprise a switch node 102, 104 coupled to any number of payload nodes 106, 108 via packet switched backplane 110. Payload node 106, 108 can add functionality to multi-service platform system 100 through the addition of processors, memory, storage devices, I/O elements, and the like. In other words, payload node 106, 108 can include any combination of processors, memory, storage devices, I/O elements, and the like, to give multi-service platform 100 the functionality desired by a user. In an embodiment, there are 18 payload slots for 18 payload nodes in multi-service platform system 100. However, any number of payload slots and payload nodes are included in the scope of the invention.

In an embodiment, multi-service platform system 100 can use switch node 102 as a central switching hub with any number of payload nodes 106, 108 coupled to switch node 102. Multi-service platform system 100 can be based on a point-to-point, switched input/output (I/O) fabric. Multi-service platform system 100 can include both node-to-node (for example computer systems that support I/O node add-in slots) and chassis-to-chassis environments (for example interconnecting computers, external storage systems, external Local Area Network (LAN) and Wide Area Network (WAN) access devices in a data-center environment). Multi-service platform system 100 can be implemented by using one or more of a plurality of switched fabric network standards, for example and without limitation, InfiniBand™, Serial Rapid™, Ethernet™, and the like. Multi-service platform system 100 is not limited to the use of these switched fabric network standards and the use of any switched fabric network standard is within the scope of the invention. In another embodiment, multiple switch nodes 102, 104 can be used in multi-service platform system 100.

In one embodiment, packet switched backplane 110 can be an embedded packet switched backplane as is known in the art. In another embodiment, packet switched backplane 110 can be an overlay packet switched backplane that is overlaid on top of a backplane that does not have packet switched capability. In any embodiment of the invention, switch node 102, 104 is coupled to payload node 106, 108 via packet switched backplane 110. In an embodiment, packet switched backplane 110 comprises plurality of packet-based links 112 capable of transmitted packet-based signal 115 from/to switch node 102, 104 and payload node 106, 108. As an example of an embodiment, each of plurality of packet-based links 112 can comprise two 100-ohm differential signaling pairs.

In an embodiment, packet switched backplane 110 can use the CompactPCI Serial Mesh Backplane (CSMB) standard as set forth in PCI Industrial Computer Manufacturers Group (PCIMG®) specification 2.20, promulgated by PCIMG, 301 Edgewater Place, Suite 220, Wakefield, Mass. CSMB provides infrastructure for applications such as Ethernet, Serial RapidIO, Ethernet, other proprietary or consortium based transport protocols, and the like. In another embodiment multi-service platform system 100 can use an Advanced Telecom and Computing Architecture (AdvancedTCA™) standard as set forth by PCIMG.

In another embodiment, packet switched backplane 110 can use VERSAmodule Eurocard (VMEbus) switched serial standard backplane (VXS) as set forth in VITA 41 promulgated by VMEbus International Trade Association (VITA), P.O. Box 19658, Fountain Hills, Ariz., 85269 (where ANSI stands for American National Standards Institute). VXS includes a packet switched network on a backplane coincident with the VMEbus parallel-type bus, where VMEbus is a parallel multi-drop bus network that is known in the art.

In an embodiment, switch node 102 can receive any number of DS3 signals 114, 116. DS3 signal 114, 116 represents a one of a series of standard digital transmission rates based on DS0, a transmission rate of 64 kilobites per second (Kbps), the bandwidth normally used for one telephone voice channel., DS3, the signal in a T-3 carrier, carries a multiple of 672 DS0 signals or 44.74 Megabites per second (Mbps). In a particular embodiment, but not limiting of the invention, switch node 102 can include twelve DS3 signals 114, 116.

Switch node 102 can include, for each DS3 signal, DS3 signal interface unit 118, 120, which can be the physical connection allowing switch node 102 to receive DS3 signal 114, 116. For example, DS3 interface unit can include a BNC or TNC type connector for DS3 signals as is known in the art. DS3 signal 114, 116 can enter switch node 102 on either the front panel or on a rear transition module of a chassis. Each DS3 signal 114, 116 is then interfaced to logic unit 122.

Logic unit 122 can comprise a serializer/de-serializer (serdes) 124 to de-serialize DS3 signal 114, 116. Logic unit 122 can also comprise a buffer 126 to provide temporary storage for DS3 data from DS3 signals 114, 116. Logic unit 122 can further comprise crosspoint switch function 128 to allow mapping and remapping of DS3 signals to payload nodes 106, 108. Logic unit translates DS3 signal 114, 116 to packet-based signal 115 so that data from DS3 signal 114, 116 can be distributed to one or more of payload nodes 106, 108 as packet-based signal 115 via packet switched backplane 110. In an embodiment, logic unit 122 can be a field programmable gate array (FPGA), and the like.

Software blocks that perform embodiments of the invention are part of computer program modules comprising computer instructions, such as control algorithms, that are stored in a computer-readable medium such as memory at logic unit 122. Computer instructions can instruct processors to perform methods of receiving and processing DS3 signals in a multi-service platform system 100, particularly at switch node 102, 104. In other embodiments, additional modules could be provided as needed.

In an embodiment, switch node 102 can include controller 130, which can control logic unit 122. In an embodiment, controller 130 can be an intelligent platform management interface (IPMI) as is known in the art. In a further embodiment, switch node 102 can include a processor peripheral component interconnect PCI mezzanine card (PrPMC) 134 coupled to any of payload nodes 106, 108 to drive controller 130.

In an embodiment, logic unit 122 is coupled to a packet-based interface 132, where packet based interface 132 provides an electrical interface with packet switched backplane 110. In an example of an embodiment, packet based interface 132 can be a standard 100BaseT Ethernet physical connection. In an embodiment, there can be a packet-based interface 132 on switch node 102 for each payload node coupled to switch node 102.

Switch node 102 is coupled to any number of payload nodes 106, 108 via packet switched backplane 110 having plurality of packet-based links 112. In an embodiment, multi-service platform system 100 can include a second switch node 104 coupled to payload nodes 106, 108. Second switch node 104 can have components (not shown for clarity) analogous to switch node 102. Second switch node 104 can receive any number of DS3 signals 140, 142 analogous to switch node 102.

Payload node 106 is coupled to packet switched backplane 110 via packet-based interface 160. A packet-based interface 160 is included for each switch node that is coupled to payload node 106. In an example of an embodiment, each packet-based interface 160 can be a standard 100BaseT Ethernet physical connection. Gasketing logic 162 is coupled to packet-based interface 160 to provide a physical interface between the electrical standards of the packet-based interface 160 and receiver 164. In an embodiment, payload node 106 includes receiver 164, which can be a standard DS3 signal receiver such as a TEMUX, and the like. In another embodiment, receiver 164 can be designed for any custom implementation of processing data from DS3 signal. In an embodiment, payload node 106 can include more than one receiver 164, as each packet-based link 112 can carry more than one DS3 signal as discussed below. Receiver 164 is coupled to processor 166, which in an embodiment, can include a digital signal processor (DSP) and cluster support in order to process DS3 signal.

A second payload node 108 can coupled to packet switched backplane 110 via packet-based interface 168. A packet-based interface 168 is included for each switch node that is coupled to payload node 108. In an example of an embodiment, each packet-based interface 168 can be a standard 100BaseT Ethernet physical connection. Gasketing logic 170 is coupled to packet-based interface 168 to provide a physical interface between the electrical standards of the packet-based interface 168 and receiver 172. In an embodiment, payload node 108 includes receiver 172, which can be a standard DS3 signal receiver such as a TEMUX, and the like. In another embodiment, receiver 172 can be designed for any custom implementation of processing data from DS3 signal. In an embodiment, payload node 108 can include more than one receiver 172, as each packet-based link 112 can carry more than one DS3 signal as discussed below. Receiver 172 is coupled to processor 174, which in an embodiment, can include a digital signal processor (DSP) and cluster support in order to process DS3 signal.

In an embodiment, packet switched backplane 110 and plurality of packet-based links 112 support 100BaseT Ethernet, which has a data rate of 100 Megabites per second (Mbps), before 4B/5B encoding. Since DS3 signals have a data rate of 44.74 Mbps, each packet-based link 112 can carry two DS3 signals. In the case where only one DS3 signal is desired, the second DS3 signal can be driven with null data. The speed difference between a pair of DS3 signals and 100BaseT Ethernet can be accommodated by either operating packet-based interface 132 at a reduced clock rate to match the pair of DS3 signal's speed, or by operating packet-based interface 132 at its standard speed of 100 Mbps and inserting flow control information into packet-based link 112 by bypassing the packet-based interface's 4B/5B encoder and implementing a data valid indication.

Since each of packet-based links can carry two DS3 signals, fault tolerance can be provided in multi-service platform system 100 for failure of a DS3 component on either switch node 102, 104 or payload node 106, 108. In one embodiment, fault tolerance is provided at the system level by including two packet-based interfaces 160 on each payload node 106 allowing simultaneous coupling to two switch nodes 102, 104. In this case, 2X redundancy is provided in each payload node. However, it is possible to double the number of receivers 164 on each payload node 106 to provide an active+active configuration in which maximum functionality is available during normal operation with a halving of capacity should a switch node fail. In the case of failure, management software at the system level can reconfigure DS3 signal mapping (remapping) using logic unit 122, in particular crosspoint switch function 128, on switch node 102. In this embodiment, distribution of DS3 signals to one or more of plurality of payload nodes 106, 108 is transparent and details of the distribution are hidden above the hardware level with no impact at a software level.

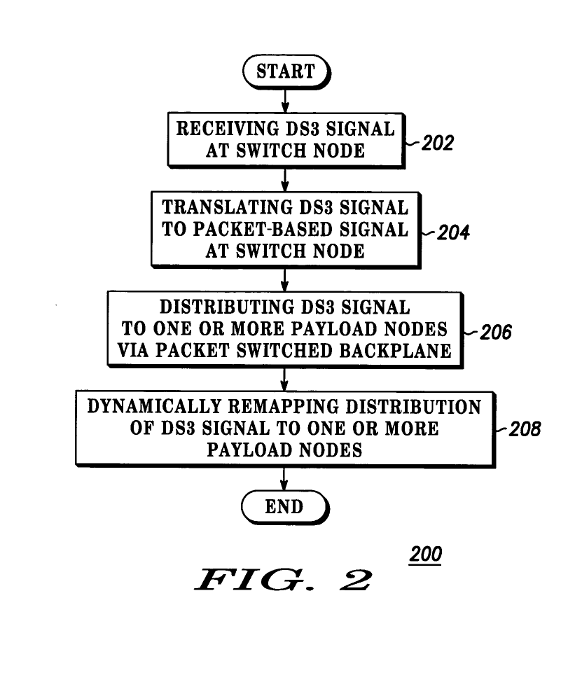

FIG.2 illustrates a flow diagram 200 according to an embodiment of the invention. In step 202, DS3 signals are received at a switch node of a multi-service platform system 100. In step 204, DS3 signal is translated to a packet-based signal at switch node. This can be accomplished in logic unit of switch node where DS3 signal is de-serialized and put into packet format. In this way, DS3 signal can be sent across packet switched backplane 110 to any number of payload nodes.

In step 206, data from DS3 signal, as the packet-based signal, is distributed to one or more of payload nodes via packet switched backplane. DS3 signals are then received and processed at the one or more payload nodes. In step 208, in case of a fault, distribution of DS3 signals can be remapped to one or more payload nodes by switch node, in particular logic unit 122 at switch node.

In another embodiment, data from two DS3 signals can be translated to a packet-based signal and distributed to one or more payload nodes, as the packet-based signal, over one of the plurality of packet-based links from the switch node to one of the plurality of payload nodes.

While we have shown and described specific embodiments of the present invention, further modifications and improvements will occur to those skilled in the art. It is therefore, to be understood that appended claims are intended to cover all such modifications and changes as fall within the true spirit and scope of the invention.

1. A multi-service platform system, comprising:
a switch node coupled to receive a DS3 signal, wherein the DS3 signal is translated to a packet-based signal at the switch node;
a plurality of payload nodes; and
a packet switched backplane coupling the switch node and the plurality of payload nodes, wherein data from the DS3 signal, as the packet-based signal, is distributed to one or more of the plurality of payload nodes via the packet switched backplane.

2. The multi-service platform system of claim 1, wherein the packet-based signal can be one of an InfiniBand, Serial RapidIO and Ethernet packet based signal.

3. The multi-service platform system of claim 1, wherein the packet switched backplane comprises a plurality of packet-based links, wherein the switch node receives a plurality of DS3 signals, and wherein data from two of the plurality of DS3 signals, as the packet-based signal, are distributed over one of the plurality of packet-based links from the switch node to one of the plurality of payload nodes.

4. The multi-service platform system of claim 1, wherein the packet switched backplane is an embedded packet switched backplane.

5. The multi-service platform system of claim 1, wherein the packet switched backplane is an overlay packet switched backplane.

6. The multi-service platform system of claim 1, wherein the DS3 signal is processed at one or more of the plurality of payload nodes.

7. The multi-service platform system of claim 1, wherein the packet switched backplane is a CompactPCI Serial Mesh backplane.

8. The multi-service platform system of claim 1, wherein the packet switched backplane is a VMEbus switched serial standard backplane.

9. The multi-service platform system of claim 1, wherein distribution of the DS3 signal to one or more of the plurality of payload nodes is dynamically remapped.

10. A method, comprising:
receiving a DS3 signal at a switch node;
translating the DS3 signal to a packet-based signal at the switch node; and
distributing data from the DS3 signal, as the packet-based signal, to one or more of a plurality of payload nodes via a packet switched backplane.

11. The method of claim 10, wherein the packet-based signal can be one of an InfiniBand, Serial RapidIO and Ethernet packet based signal.

12. The method of claim 10, wherein the packet switched backplane comprises a plurality of packet-based links between the switch node and the plurality of payload nodes, wherein receiving a DS3 signal comprises receiving a plurality of DS3 signals at the switch node, and wherein distributing the DS3 signal comprises distributing data from two of the plurality of DS3 signals, as the packet-based signal, over one of the plurality of packet-based links from the switch node to one of the plurality of payload nodes.

13. The method of claim 10, wherein the packet switched backplane is an embedded packet switched backplane.

14. The method of claim 10, wherein the packet switched backplane is an overlay packet switched backplane.

15. The method of claim 10, further comprising processing the DS3 signal at one or more of the plurality of payload nodes.

16. The method of claim 10, wherein the packet switched backplane is a CompactPCI Serial Mesh backplane.

17. The method of claim 10, wherein the packet switched backplane is a VMEbus switched serial standard backplane.

18. The method of claim 10, further comprising dynamically remapping distribution of the DS3 signal to one or more of the plurality of payload nodes.

19. A switch node comprising a computer-readable medium containing computer instructions for instructing a processor to perform a method of receiving and processing a DS3 signal in a multi-service platform system, the instructions comprising:
receiving the DS3 signal at the switch node;
translating the DS3 signal to a packet-based signal at the switch node; and
distributing data from the DS3 signal, as the packet-based signal, to one or more of a plurality of payload nodes via a packet switched backplane.

20. The computer-readable medium of claim 19, wherein the packet-based signal can be one of an InfiniBand, Serial RapidIO and Ethernet packet based signal.

21. The computer-readable medium of claim 19, wherein the packet switched backplane comprises a plurality of packet-based links between the switch node and the plurality of payload nodes, wherein receiving a DS3 signal comprises receiving a plurality of DS3 signals at the switch node, and wherein distributing the DS3 signal comprises distributing data from two of the plurality of DS3 signals, as the packet-based signal, over one of the plurality of packet-based links from the switch node to one of the plurality of payload nodes.

22. The computer-readable medium of claim 19, wherein the packet switched backplane is an embedded packet switched backplane.

23. The computer-readable medium of claim 19, wherein the packet switched backplane is an overlay packet switched backplane.

24. The computer-readable medium of claim 19, further comprising processing the DS3 signal at one or more of the plurality of payload nodes.

25. The computer-readable medium of claim 19, wherein the packet switched backplane is a CompactPCI Serial Mesh backplane.

26. The computer-readable medium of claim 19, wherein the packet switched backplane is a VMEbus switched serial standard backplane.

27. The computer-readable medium of claim 19, further comprising dynamically remapping distribution of the DS3 signal to one or more of the plurality of payload nodes.
